(19) United States
(12) Patent Application Publication
(10) Pub. No.: US 2023/0324238 A1
(43) Pub. Date: Oct. 12, 2023

(54) METHOD OF PACKAGING OPTICAL FIBER FOR SIMULTANEOUS TEMPERATURE AND STRAIN MEASUREMENT FACILITATING INDUSTRIAL ASSET MANAGEMENT

(71) Applicant: Baker Hughes Oilfield Operations LLC, Houston, TX (US)

(72) Inventors: Navin Sakthivel, Spring, TX (US); Aaron Avagliano, Tomball, TX (US); Paul Wysocki, Blacksburg, VA (US); Juan Franco, Blacksburg, VA (US); Holger Stibbe, Humble, TX (US)

(21) Appl. No.: 18/193,135

(22) Filed: Mar. 30, 2023

Related U.S. Application Data
(60) Provisional application No. 63/326,679, filed on Apr. 1, 2022.

(51) Int. Cl. G01L 1/24; G01K 11/324; G01B 11/16

(52) U.S. Cl. CPC G01L 1/246; G01B 11/165; G01K 11/324

(57) ABSTRACT

A sensor and a method of manufacture of a sensor. The sensor includes a body having a groove therein, a first optical fiber and second optical fiber disposed in the groove, and a first layer and second layer bonded in the groove. The groove is formed in the body of the sensor. The first optical fiber is deposited in the groove. The first layer is bonded in the groove to form a first chamber in which the first optical fiber is disposed. The second optical fiber is disposed in the groove. The second layer is bonded in the groove to form a second chamber in which the second optical fiber is disposed.

### CROSS-REFERENCE TO RELATED APPLICATIONS

This application claims the benefit of U.S. Provisional Pat. Application No. 63/326,679 filed Apr. 1, 2022, the disclosure of which is incorporated herein by reference in its entirety.

### BACKGROUND

In the various industries, devices are used to contain or transport fluids or gases over a distance. These devices will generally undergo various stresses and temperature changes. For various reasons, it is desirable to know these stresses, either to know the integrity of the device or to be able measure a parameter of the fluid or gas. Optical fibers can be used to measure various parameters but need to be protected for corrosive elements in the process of making such measurements.

### SUMMARY

In one aspect, a method of manufacturing a sensor is disclosed. A groove is formed in a body of the sensor. A first optical fiber is deposited in the groove. A first layer is bonded in the groove to form a first chamber in which the first optical fiber is disposed. A second optical fiber is disposed in the groove. A second layer is bonded in the groove to form a second chamber in which the second optical fiber is disposed.

In another aspect, a sensor is disclosed. The sensor includes a body having a groove therein, a first optical fiber disposed in the groove, a first layer bonded in the groove to form a first chamber in which the first optical fiber is disposed, a second optical fiber disposed in the groove, and a second layer bonded in the groove to form a second chamber in the groove in which the first optical fiber is disposed.

### BRIEF DESCRIPTION OF THE DRAWINGS

The following descriptions should not be considered limiting in any way. With reference to the accompanying drawings, like elements are numbered alike:

FIG. 1 shows an article used in various industrial applications.

FIG. 2 shows a cross-sectional view of a sensor of the article;

FIG. 3 shows a side cross-sectional view of the sensor body;

FIG. 4 shows a flowchart of a method of manufacturing the sensor in the article;

FIG. 5 shows a side cross-sectional view of the sensor body in another embodiment; and

FIG. 6 shows a flowchart of a method of manufacturing the sensor in the article.

### DETAILED DESCRIPTION

A detailed description of one or more embodiments of the disclosed apparatus and method are presented herein by way of exemplification and not limitation with reference to the Figures.

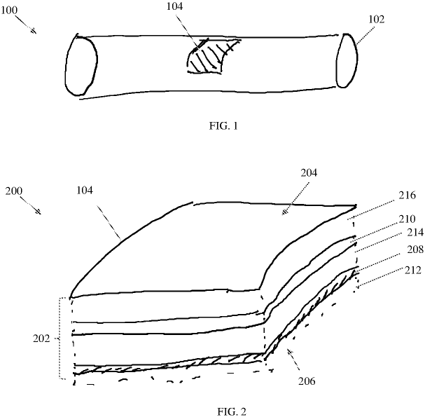

Referring to FIG. 1, an article 100 used in various industrial applications is shown. In various embodiments, the industrial application can be distillation, carbon capture, etc. The article 100 includes a body 102 having a sensor 104. In various embodiments, the article 100 is a tube or conduit through which a fluid mixture flows. The fluid mixture can be one or more liquids, one or more gases, or some combination thereof. The sensor 104 can be used to sense various parameters of the fluid mixture. In one aspect, the sensor 104 can sense a temperature of the fluid mixture and/or a concentration of a selected component of the fluid mixture.

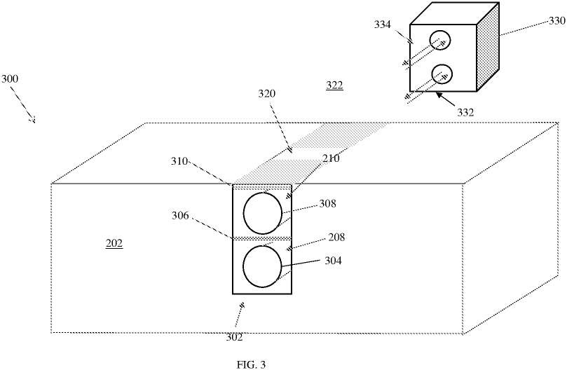

FIG. 2 shows a cross-sectional view 200 of the sensor 104. The sensor 104 includes a sensor body 202 extending from first surface 204 to a second surface 206. The first surface 204 can be a top surface or outer surface of the sensor 104 and the second surface 206 can be a bottom surface or inner surface of the sensor 104. In another embodiment, the first surface 204 can be an inner surface of the sensor 104 and the second surface 206 can be an outer surface of the sensor 104

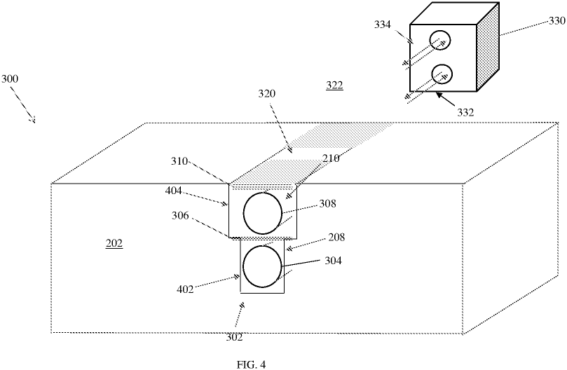

Either the first surface 204 or the second surface 206 can be in contact with the fluid mixture. A first chamber 208 and a second chamber 210 are formed with the sensor body 202. A lower section 212 and a middle section 214 form bottom and top surfaces, respectively, of the first chamber 208. The middle section 214 and a top section 216 form bottom and top surfaces, respectively, of the second chamber 210. A first optical fiber can be disposed in the first chamber 208 and a second optical fiber can be disposed in the second chamber 210, as discussed herein with respect to FIG. 3.

FIG. 3 shows a side cross-sectional view 300 of the sensor body 202 in an embodiment. A groove 302 is created in the sensor body 202. A first optical fiber 304 is disposed at a bottom of the groove 302 and a first metal layer 306 is formed over the first optical fiber 304 to create the first chamber 208. In various embodiments, the first metal layer 306 includes a plurality of metal foils that are bonded to the sides of the groove 302 using a process of ultrasonic bonding. A second optical fiber 308 is disposed in the groove 302 over the first metal layer 306. A second metal layer 310 is formed over the second optical fiber 308 to create the second chamber 210. In various embodiments, the second metal layer 310 can be non-continuous, leaving a gap 320. The gap 320 exposes the second optical fiber 308 to the environment 322 outside of the sensor. Alternatively, the second metal layer 310 can be made of a mesh-like or porous material.

In various embodiments, the second metal layer 310 includes a plurality of metal foils that are bonded to the sides of the groove 302 using a process of ultrasonic bonding. Ultrasonic bonding uses ultrasonic vibrations to join metals or dissimilar materials together. The plurality of metal foil layers are disposed within the groove 302. An ultrasonic wave generator is activated to transmit ultrasonic waves at the metal foil layers, causing mechanical vibrations in the plurality of metal foils that join them to each other and to the side walls of the groove 302. The first metal layer 306 and the second metal layer 310 can be bonded either at the same time or at different times.

An optical interrogator 330 propagates light along a first optical path 332 and through the first optical fiber 304 to obtain a temperature measurement and a propagates light along a second optical path through the second optical fiber 308 to obtain a stress measurement.

In various embodiments, the first optical fiber 304 is a temperature sensing optical fiber. The temperature sensing optical fiber can use various techniques, such as a Fiber Bragg grating, Raman distributed temperature sensing (DTS) and optical frequency domain reflectometry (OFDR). When using a Bragg grating, the first optical fiber 304 is placed within the groove 302 so that the fiber is strain fee. Thus, the wavelength of light reflected by the Bragg grating is responsive only to changes in temperature. The wavelength of the reflected light is measured to determine the temperature. When using DTS, the change in temperature affects the magnitude of light generated in response to light that is propagated by the optical interrogator 330, due to a nonlinear optical effect known as the Raman effect. DTS can be performed without the temperature sensing optical fiber being strain free. When using OFDR, a measurements is made of changes in a scattering pattern of light by the fiber. OFDR can be performed the temperature sensing optical fiber either being strain free or having a strain.

The second optical fiber 308 is a strain-sensing optical fiber. A strain on the second optical fiber 308 changes a wavelength of a reflected light signal propagating through the optical fiber. The wavelength of the reflected light is used to determine a magnitude of the strain on the second optical fiber 308. The second optical fiber 308 can include Bragg gratings therein for reflecting the light. Since a strain at the second optical fiber 308 can also be due to temperature, measurements of temperature taken at the first optical fiber 304 can be used to provide a temperature adjustment to the measurement of strain made at the second optical fiber 308.

The first optical fiber 304 (i.e., temperature--sensing optical fiber) is free to move within the first chamber 208 so that any stress on the sensor body 202 is not transferred to the first optical fiber 304. Thus, a temperature measurement obtained by the first optical fiber 304 is independent of or substantially unaffected by any strain occurring at the sensor body 202. In other words, stress on the sensor body is not transferred to the first optical fiber 304. In various embodiments, this transfer of stress is prevented by depositing excess fiber length into the groove 302. Thus, if the temperature sensing optical fiber is unable to slide against the sensor body 202, any strain on the temperature-sensing optical fiber is accommodated by the excess fiber length so that little or no stress occurs. The second optical fiber 308 (i.e., the strain-sensing optical fiber) is disposed within the second chamber 210 so as to be locked or secured in place with respect to the sensor body 202. In this configuration. a strain measurement obtained at the second optical fiber 308 is representative of a stress on the sensor body 202. In other words, stress on the sensor body is transferred to the second optical fiber 308. In another embodiment, the first optical fiber 304 can be the strain sensing optical fiber while the second optical fiber 308 is the temperature sensing optical fiber.

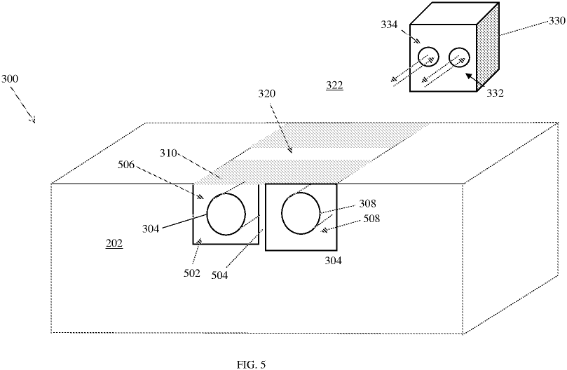

FIG. 4 shows a side cross-sectional view 400 of the sensor body 202 in another embodiment. The groove 320 includes a first level 402 having a first width and a second level 404 having a second width. The first level 402 is located beneath the second level 404, and the first width is less than the second width. The first optical fiber 304 is disposed in the first level 402 and the first metal layer 306 is formed over the first optical fiber 304 to create the first chamber 208 in the first level 402. The second optical fiber 308 is disposed in the second level 404 and the second metal layer 310 is formed over the second optical fiber 308 to create the second chamber 210 in the second level 404. In various embodiments, the first optical fiber 304 is the temperature sensing optical fiber and is free to move within the first chamber 208 and the second optical fiber 308 is a strain-sensing optical fiber and is secured into place within the second chamber 210. The dimensions of the metal foil of each of the first metal layer 306 and of the second metal layer 308 can be selected according to the widths of the respective levels.

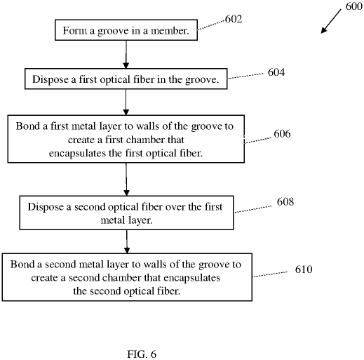

FIG. 5 shows a side cross-sectional view 500 of the sensor body 202 in another embodiment. The sensor body 202 includes a first chamber 502 and a second chamber 508 formed side by side within the sensor body 202. The first chamber 502 and the second chamber 508 can be of different depths and/or widths. The first groove 502 holds the first optical fiber 304 and the second groove 508 holds the second optical fiber 308. A metal divider 504 separates the first chamber 502 from the second chamber 508. A top metal layer 310 is placed over both the first chamber 502 and the second chamber 508 as well as the metal divider 504.

FIG. 6 shows a flowchart 600 of a method of manufacturing the sensor 104 in the article 100. In box 602, a groove is created within the sensor body. In box 604, a first optical fiber 304 is disposed or deposited within the groove. In box 606, a first metal layer is formed within the groove to create a first chamber that encapsulates the first optical fiber 304 or in which the first optical fiber 304 is disposed. In box 608, a second optical fiber 308 is disposed or deposited within the groove over the first layer. In box 610, a second layer is formed within the groove to create a second chamber that encapsulates the second optical fiber 308 or in which the second optical fiber 308 is disposed.

Set forth below are some embodiments of the foregoing disclosure:

Embodiment 1: A method of manufacturing a sensor. A groove is formed in a body of the sensor. A first optical fiber is deposited in the groove. A first layer is bonded in the groove to form a first chamber in which the first optical fiber is disposed. A second optical fiber is disposed in the groove. A second layer is bonded in the groove to form a second chamber in which the second optical fiber is disposed.

Embodiment 2: The method of any previous embodiment, further including forming the first chamber so that a stress on the sensor is not transferred to the first optical fiber and forming the second chamber so that stress on the sensor is transferred to the second optical fiber.

Embodiment 3: The method of any previous embodiment, further including depositing the first optical fiber in a first level of the groove having a first width and depositing the second optical fiber in a second level of the groove having a second width, wherein the first width is less than the second width.

Embodiment 4: The method of any previous embodiment, wherein one of: (i) the second chamber is on top of the first chamber; and (ii) the first chamber and the second chamber are at a same depth within the groove.

Embodiment 5: The method of any previous embodiment, further including forming at least one of the first layer and the second layer using ultrasonic bonding.

Embodiment 6: The method of any previous embodiment, wherein at least one of the first layer and the second layer includes a plurality of metal foils, and wherein bonding the at least one of the first layer and the second includes bonding the plurality of metal foils to each other using an ultrasonic bonding.

Embodiment 7: The method of any previous embodiment, wherein the second metal layer is formed with a gap which exposes the second optical fiber to an environment outside of the sensor.

Embodiment 8: A sensor including a body having a groove therein, a first optical fiber disposed in the groove, a first layer bonded in the groove to form a first chamber in which the first optical fiber is disposed, a second optical fiber disposed in the groove, and a second layer bonded in the groove to form a second chamber in the groove in which the first optical fiber is disposed.

Embodiment 9: The sensor of any previous embodiment, wherein the first optical fiber is disposed within the first chamber so that a stress on the sensor is not transferred to the first optical fiber and the second optical fiber is disposed within the second chamber so that a stress on the sensor is transferred to the second optical fiber.

Embodiment 10: The sensor of any previous embodiment, wherein the first optical fiber is disposed in a first level of the groove and the second optical fiber is disposed in a second level of the groove, the first level having a first width and the second level having a second width, the first width being less than the second width.

Embodiment 11: The sensor of any previous embodiment, wherein one of: (i) the second chamber is on top of the first chamber; and (ii) the first chamber and the second chamber are at a same depth within the groove.

Embodiment 12: The sensor of any previous embodiment, wherein at least one of the first layer and the second layer are bonded in the groove using ultrasonic bonding.

Embodiment 13: The sensor of any previous embodiment, wherein at least one of the first layer and the second layer includes a plurality of metal foils bonded to each other using an ultrasonic bonding.

Embodiment 14: The sensor of any previous embodiment, wherein the second metal layer includes with a gap which exposes the second optical fiber to an environment.

Embodiment 15: The sensor of any previous embodiment, further including an optical interrogator configured to propagate light along first optical path through the first optical fiber obtain a temperature measurement and to propagate light along second optical path through the second optical fiber to obtain a stress measurement.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ± 8% or 5%, or 2% of a given value.

The teachings of the present disclosure may be used in a variety of well operations. These operations may involve using one or more treatment agents to treat a formation, the fluids resident in a formation, a borehole, and / or equipment in the borehole, such as production tubing. The treatment agents may be in the form of liquids, gases, solids, semi-solids, and mixtures thereof. Illustrative treatment agents include, but are not limited to, fracturing fluids, acids, steam, water, brine, anticorrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A method of manufacturing a sensor, comprising:
forming a groove in a body of the sensor;
depositing a first optical fiber in the groove;
bonding a first layer in the groove to form a first chamber in which the first optical fiber is disposed;
depositing a second optical fiber in the groove; and
bonding a second layer in the groove to form a second chamber in which the second optical fiber is disposed.

2. The method of claim 1, further comprising forming the first chamber so that a stress on the sensor is not transferred to the first optical fiber and forming the second chamber so that stress on the sensor is transferred to the second optical fiber.

3. The method of claim 1, further comprising depositing the first optical fiber in a first level of the groove having a first width and depositing the second optical fiber in a second level of the groove having a second width, wherein the first width is less than the second width.

4. The method of claim 1, wherein one of: (i) the second chamber is on top of the first chamber; and (ii) the first chamber and the second chamber are at a same depth within the groove.

5. The method of claim 1, further comprising forming at least one of the first layer and the second layer using ultrasonic bonding.

6. The method of claim 1, wherein at least one of the first layer and the second layer includes a plurality of metal foils, and wherein bonding the at least one of the first layer and the second includes bonding the plurality of metal foils to each other using an ultrasonic bonding.

7. The method of claim 1, wherein the second metal layer is formed with a gap which exposes the second optical fiber to an environment outside of the sensor.

8. A sensor, comprising:
a body having a groove therein;
a first optical fiber disposed in the groove;
a first layer bonded in the groove to form a first chamber in which the first optical fiber is disposed;
a second optical fiber disposed in the groove; and
a second layer bonded in the groove to form a second chamber in the groove in which the first optical fiber is disposed.

9. The sensor of claim 8, wherein the first optical fiber is disposed within the first chamber so that a stress on the sensor is not transferred to the first optical fiber and the second optical fiber is disposed within the second chamber so that a stress on the sensor is transferred to the second optical fiber.

10. The sensor of claim 8, wherein the first optical fiber is disposed in a first level of the groove and the second optical fiber is disposed in a second level of the groove, the first level having a first width and the second level having a second width, the first width being less than the second width.

11. The sensor of claim 8, wherein one of: (i) the second chamber is on top of the first chamber; and (ii) the first chamber and the second chamber are at a same depth within the groove.

12. The sensor of claim 8, wherein at least one of the first layer and the second layer are bonded in the groove using ultrasonic bonding.

13. The sensor of claim 8, wherein at least one of the first layer and the second layer includes a plurality of metal foils bonded to each other using an ultrasonic bonding.

14. The sensor of claim 8, wherein the second metal layer includes with a gap which exposes the second optical fiber to an environment.

15. The sensor of claim 8, further comprising an optical interrogator configured to propagate light along first optical path through the first optical fiber obtain a temperature measurement and to propagate light along second optical path through the second optical fiber to obtain a stress measurement.
